(19) United States
(12) Patent Application Publication
(10) Pub. No.: US 2008/0307412 A1
(43) Pub. Date: Dec. 11, 2008

(54) CACHED CONTENT CONSISTENCY MANAGEMENT

(75) Inventors: James E. Marr, Burlingame, CA (US); Payton R. White, Foster City, CA (US); Stephen C. Detwiler, Oakland, CA (US); Attila Vass, Foster City, CA (US)

Correspondence Address: JOSHUA D. ISENBERG;JDI PATENT, 809 CORPORATE WAY, FREMONT, CA, 94539, US

(73) Assignee: Sony Computer Entertainment Inc., Tokyo (JP)

(21) Appl. No.: 11/759,155

(22) Filed: Jun. 6, 2007

(51) Int. Cl. G06F 9/445

(52) U.S. Cl. 717/177

(57) ABSTRACT

A method and system for managing consistency of cached content assets are disclosed. A distribution server and client device that may be used in conjunction with such a system and method are also disclosed.

### CROSS-REFERENCE TO RELATED APPLICATION

This application is related to commonly assigned U.S. patent application ______, to James E. Marr et al. entitled “MEDIATION FOR AUXILIARY CONTENT IN AN INTERACTIVE ENVIRONMENT”, attorney docket number SCEA07010US00, filed the same day as the present application, the entire contents of which are incorporated herein by reference.

### FIELD OF THE INVENTION

This invention is related to electronic computing and more particularly to management of cached content in an interactive environment.

### BACKGROUND OF THE INVENTION

The growth of the Internet and the popularity of interactive entertainment such as video games have led to opportunities for advertising within video games. At first, advertisements were statically placed within video games. As video game consoles with internet connectivity became available, it became possible to update advertisements appearing within video games. This led to many avenues for game console manufacturers and video game companies to generate revenue from the sale of advertising space within video games to one or more advertisers. Advertising content often varies based on the nature of the video game title. In addition, certain advertising spaces within the game may be more valuable than others. Furthermore, advertising campaigns may change over time with certain advertisements being phased out as others are phased in. It is therefore useful to have some system for determining which advertisements are to be placed in particular spaces within particular video games during particular periods of time.

Conventionally, a video game console may connect to a distribution server that determines what advertisement to place in a particular advertising space within the game based on considerations such as the game title and the time of day, month year, etc. Often the actual advertising content is stored on a separate server known as a content server. In such a case, the distribution server instructs the game console to contact a particular content server and to request one or more content file or files referred to herein as content assets that a video game console may use to generate the content for a particular advertising space. The console can then directly contact the content server and request the designated content assets. These content assets may be temporarily stored in a cache on the video game console to facilitate quick updating of the content in advertising spaces within the video game.

Advertisers often seek some form of exclusivity for their advertisements. Such exclusivity is often agreed to in contracts with media companies that are responsible for delivery of advertising content. An exclusivity agreement between and advertiser and a media company may provide that advertisements promoting a products or services of the advertiser's competitors will not be displayed in a particular media channel at a particular time. As an example, this may mean that advertisements for competing companies may not be shown in the same frame of a video game. There are numerous possible permutations on this example.

Due to the dynamic nature of the distribution of information over computer networks, advertising displayed within video games may be updated quite rapidly. It is desirable to avoid conflicts between advertisements or other content when implementing updates.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a schematic diagram of an auxiliary content distribution system according to an embodiment of the present invention.

FIG. 2A is a flow diagram illustrating the problem of cached consistency management in the prior art.

FIG. 2B is a flow diagram illustrating an example of cached content consistency management according to an embodiment of the present invention.

FIG. 3 is a block diagram illustrating a client device according to an embodiment of the present invention.

FIG. 4 is a block diagram illustrating a distribution server according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

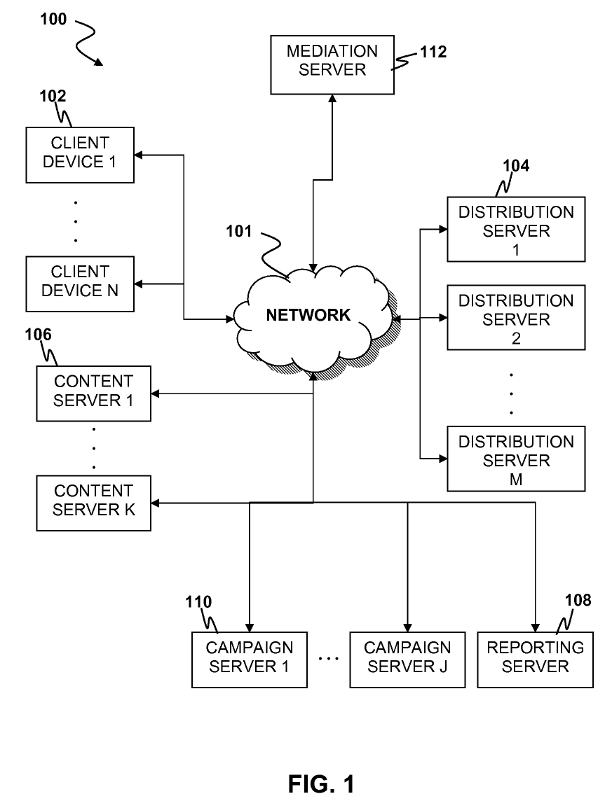

As seen in FIG. 1 a cached content consistency management system 100 may include one or more client devices 102 and one or more distribution servers 104. The client devices 102 and distribution servers 104 may be configured to communicate with each other over a network 101. By way of example, and without loss of generality, the network 101 may be a bi-directional digital communications network. The network 101 may be a local area network or wide area network such as the Internet. The network 101 may be implemented, e.g., using an infrastructure, such as that used for CATV bi-directional networks, ISDN or xDSL high speed networks to enable network connections for implementing certain embodiments of the present invention.

By way of example, and without limitation, the client devices 102 may be video game consoles. Examples of commercially game consoles include the Xbox® from Microsoft Corporation of Redmond Wash., the Wii® from Nintendo Company, Ltd of Kyoto, Japan and PlayStation® devices, such as the PlayStaion3 from Sony Computer Entertainment of Tokyo, Japan. Xbox® is a registered trademark of Microsoft Corporation of Redmond, Wash. PlayStation® is a registered trademark of Kabushiki Kaisha Sony Computer Entertainment of Tokyo, Japan. Wii® is a registered trademark of Nintendo Company, Ltd of Kyoto, Japan. Alternatively, the client devices may be any other type of network capable device. Such devices include, but are not limited to cellular telephones, personal computers, laptop computers, television set-top boxes, portable internet access devices, portable email devices, portable video game devices, personal digital assistants, digital music players, and the like. Furthermore, the client devices 102 may incorporate the functions of two or more of the devices in the examples previously listed.

As used herein the term content refers to images, video, text, sounds, etc. presented on a display in a simulated environment. Such content may include content that is an integral part of the simulated environment, e.g., background scenery, avatars, and simulated objects that are used within the simulated environment. Content may also include auxiliary content that is not integral to the simulated environment, but which may appear within it. As used herein, the term auxiliary content means content, e.g., in the form of text, still images, video images, animations, sounds, applets, three-dimensional content, etc, that is provided gratuitously to the client device 102. By way of example, and without limitation, within the context of an interactive environment, e.g., a video game, three-dimensional content may include information relating to images or simulations involving three dimensions. Examples of such information may range from static geometry through to a subset of a game level or a full game level with all of the expressive interactivity of the game title itself. Examples of auxiliary content include advertisements, public service announcements, software updates, interactive game content, and the like.

Content, including auxiliary content, may be generated by the client devices from content assets. As used herein, the term “content assets” refers to information in a format readable by the client device that the client device may use to generate the content. Content, including auxiliary content, and corresponding content assets may be created “on the fly”, i.e., during the course of a simulated environment session.

The auxiliary content may appear at one or more pre-defined locations or instances of time in a simulated environment generated by the client device 102. As used herein, the term “simulated environment” refers to text, still images, video images, animations, sounds, etc, that are generated by the client device 104 during operation initiated by a user of the device. By way of example, and without limitation, a simulated environment may be a landscape within a video game that is represented by text, still images, video images, animations, sounds that the client device 104 presents to the user.

The client devices 104 may retrieve the auxiliary content assets from one or more content servers 106. The distribution servers 104 may determine which particular items of auxiliary content belong in particular spaces or time instances within the simulated environments generated by the client devices 104. Each distribution server 104 may be responsible for distribution of auxiliary content to client devices 102 in different regions.

In certain implementations, e.g., where the cached content includes advertising content, the system may optionally include one or more content servers 106 and one or more reporting servers 108 one or more campaign management servers 110. In some implementations, the system may include an optional mediation server 112 to facilitate distribution of content. Each client device 102 may be configured to submit input to the mediation server 112. The mediation server 112 may act as an intermediary between the client devices 102 and the distribution servers 104. By way of example, the mediation server 112 may determine which distribution server 104 handles auxiliary content distribution for a client device in a particular region. The mediation server 112 may be configured to receive the input from a client device 102 and send contact information for a distribution server 104 to the client device 102 in response to the input. Each client device 102 may be further configured to receive the contact information from the mediation server 112 and use the contact information to contact one or more of the distribution servers 104 with a request for auxiliary content information for an auxiliary content space. The distribution servers 104 may be configured to service requests for auxiliary content information from the one or more client devices 102. The mediation server 112 may have a pre-existing trust relationship with each client device 102. By way of example, the trust relationship may be established using Public key cryptography, also known as asymmetric cryptography. The pre-existing trust relationship between the client device 102 and mediation server 112 may be leveraged to delegate management of multiple distribution servers 104. The use of mediation servers in conjunction with auxiliary content distribution is described in commonly assigned U.S. patent application ______, to James E. Marr et al.,entitled “MEDIATION FOR AUXILIARY CONTENT IN AN INTERACTIVE ENVIRONMENT” which has been incorporated herein by reference.

In some embodiments, the system 100 may further include one or more reporting servers 108 coupled to the network 101. Client devices 102 may report user activity related to the auxiliary content. For example, in the case of auxiliary content in the form of advertising, the client devices 104 may be configured to report information to the reporting server 108 relating to whether an advertisement was displayed and/or made an impression on the user. Examples of such impression reporting are described, e.g., in commonly-assigned U.S. patent application Ser. No. 11/241,229, filed Sep. 30, 2005, the entire contents of which are incorporated herein by reference. In some embodiments, the mediation server 112 may also provide a URL for a reporting server 108 and a cryptographic key for communicating with the reporting server.

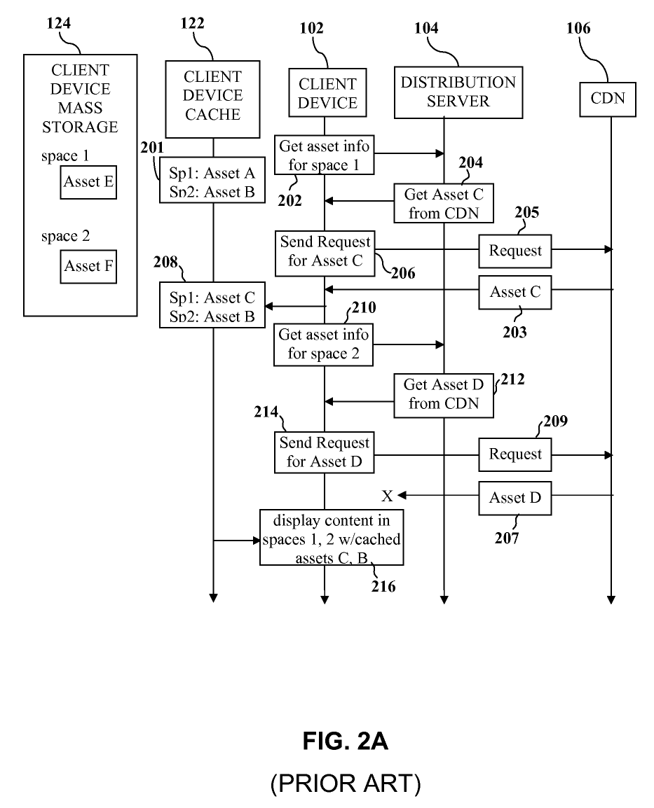

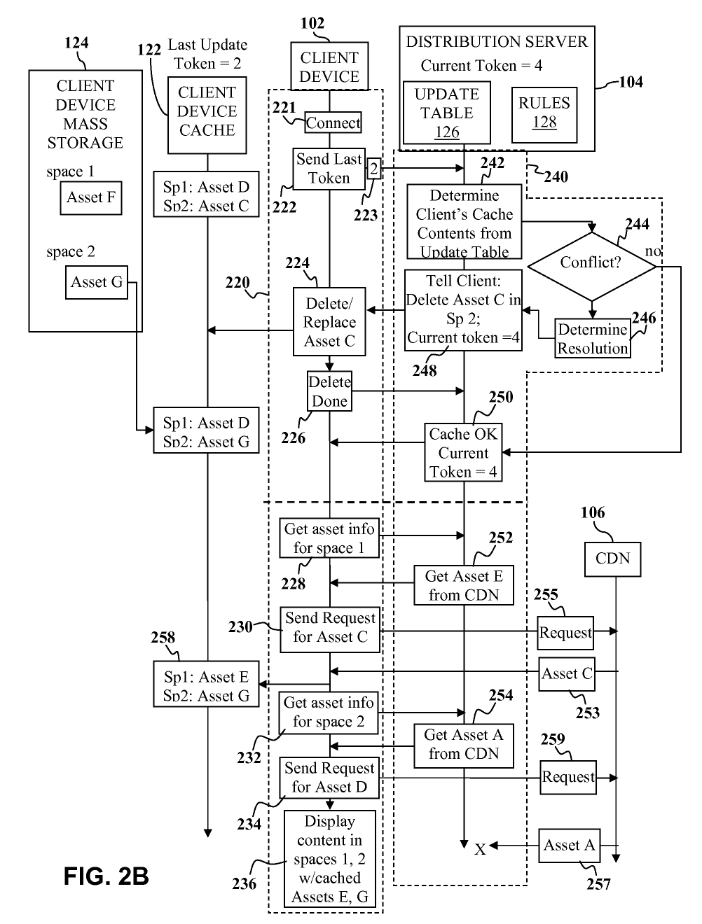

FIG. 2A illustrates the problem of managing cached content as often encountered in the prior art. In this example, the client device 102 has a cache 122 that contains content assets for first and second content spaces Sp1, Sp2, within a simulated environment.

As used herein, the term cache generally refers to a special high-speed storage mechanism. By way of example, the cache 122 may be a reserved section of a main memory associated with the client device 102 or an independent high-speed storage device associated with the client device. Initially, the cache 122 may contain asset A for the first space Sp1 and asset B for the second space Sp2, as indicated at 201. The content assets stored in the cache 122 may be updated from time to time. To update the content assets, the client device 102 contacts the distribution server over the network 101 with a request for asset information as indicated at 202. The distribution server responds the request with asset information, as indicated at 204. The asset information may identify update assets, e.g., by filenames or some other identifier, and a source of the update assets. The source, e.g., a content server 106 may be identified by a network address, e.g., a URL. In this example, the distribution server determines that the client device 102 should obtain Asset C 203 from a content server 106 at address CDN. The distribution server relays this information to the client device 102 as indicated at 204. As indicated at 206, the client device 102 may then use this information to send a request 205 for Asset C 203 to the content server 106 at address CDN. In response, the content server 106 sends asset C 203 to the client device. The client device may then replace Asset A with Asset C 203 in the cache 122, as shown at 208.

Subsequently, the client device 102 may request asset information for content space Sp2 from the distribution server 104 as indicated at 210. In this example, the distribution server sends a response indicating that Asset D 207 may be obtained from the content server 106 at network address CDN. At 214, the client device sends a request 209 for Asset D 207. The client device is often configured such that if it receives no reply to a request for asset information for a content space, it will use cached assets to generate content for the space. However, client device 102 generally has no way to determine whether the cached assets are consistent with each other. For example, Asset B and Asset C may be used to generate conflicting advertisements, which would be displayed at 216. However, to determine that these two or more cached content assets may produce a conflict, the client device 102 would have to be programmed with rules governing conflicting content. Since the number of potentially conflicting assets and conflict rules may be very large this can be an awkward and difficult solution to implement. The difficulty may be further compounded if the rules change over time and/or if the rules must be distributed regularly to a large number of client devices.

In some cases, the client device may have benign content assets stored in a mass storage device 124 that may be displayed if no other content is available (e.g., if no other content assets are stored in the cache 122). Such assets may generate benign content that is configured in advance such that does not present a conflict with any other content. By way of example, benign content Assets E and F may be used to generate advertisements that never present a conflict. For example, the client device 102 may use Assets E and F may to generate advertisements promoting the manufacturer of the client device 102. The manufacturer may have agreed in advance with other advertisers that such advertisements do not present a conflict. Unfortunately, such advertisements may not generate advertising revenue for the manufacturer of the client device. Therefore it may be desirable to avoid displaying benign assets unless absolutely necessary.

The above example illustrates the general problem of cache consistency management. The nature of the problem, as seen from the above example, is that content assets cached on a client device may be inconsistent due to frequent updates and intermittent interruptions in network communication. Cached content assets may be inconsistent in many different ways. For example, the content generated by the cached content assets may simply be out of date or no longer valid.

One way in which cached content assets may be inconsistent can occur if a download is interrupted by an application, such as a game. For example, many games will allow a fixed amount of time for new assets to be downloaded. For example, games might only allow new assets to be downloaded while the next level of game content is loaded from a mass storage device such as a Blu-Ray drive. Once all game content has been loaded, the game may interrupt the asset downloading (a client library may allow a game to perform this interruption). This may stop an asset download regardless of whether it has been completed. Since the download speed of internet connections may vary widely, different client devices 102 may take different amounts of time to download the newest assets. However, all client devices 102 of the same type, e.g., specific models of a particular game console, typically load game content assets at the same speed, implying that some client devices may successfully download all new assets while others may only download a portion of the newest assets before being interrupted.

Cached content assets may also be inconsistent, e.g., if the distribution servers 104 or content servers 106 are under heavy network load. When servers are over burdened with requests from client devices 102, a server may appear to be unavailable to a particular client device 102. Consequently, a request for content information from a distribution server 104 or a request for assets from a content server 106 may randomly fail due to high network load at the server.

To overcome such problems, embodiments of the present invention implement certain aspects of management consistency of content assets cached on a client device using the distribution server. By way of example, as shown in FIG. 2B, the distribution server 104 may have an update table 126 stored in memory. The update table may be configured to keep track of which content assets are associated with different content spaces at each update. A token value is associated with each update. Each time the content is to be updated on the client device 102, the distribution server sends the client device the token value that is associated with the update. The update table 126 includes information from which the distribution server 104 may determine which content assets might currently be stored in the client device's cache 122 as of that update token value. For example, the update table may indicate a plurality of listings indicating which content assets are to be cached for particular content spaces as of each update token value.

By way of example, the update table 126 may be configured as shown in Table I below.

TABLE I

| Token Value | Sp1 | Sp2 | . . . |
|---|---|---|---|
| 0 | Asset A | Asset B | . . . |
| 1 | Asset A | Asset C | . . . |
| 2 | Asset D | Asset C | . . . |
| 3 | Asset D | Asset A | . . . |
| 4 | Asset E | Asset A | . . . |
| 5 | . . . | . . . | . . . |

The distribution server 104 may further have a set of conflict rules 128 stored in memory. The conflict rules 128 may be configured to prevent assets for two or more conflicting content items being stored in the client device cache 122 at substantially the same time. Furthermore, the conflict rules 128 may be configured to prevent the client device 102 from displaying two or more conflicting content items. By way of example, the rules may be implemented as by performing a lookup in one or more conflict tables, which may be organized as shown in Table II below.

TABLE II

| Asset | A | B | C | D | E | F | G |
|---|---|---|---|---|---|---|---|
| A | OK | OK | OK | OK | OK | OK | OK |
| B | OK | OK | OK | OK | OK | OK | OK |
| C | OK | OK | OK | OK | Conflict | OK | OK |
| D | OK | OK | OK | OK | OK | OK | OK |
| E | OK | OK | Conflict | OK | OK | OK | OK |
| F | OK | OK | OK | OK | OK | OK | OK |
| G | OK | OK | OK | OK | OK | OK | OK |

According to the example illustrated in Table II, Asset C and Asset E conflict. All other combinations of assets in the cache are permitted. It is assumed, for simplicity's sake, that an asset never conflicts with itself. A two-dimensional cross-reference table is used to illustrate the concept of conflicts between pairs of assets. The concept may be generalized to cross-reference tables in three or more dimensions to establish conflict rules for combinations of three or more assets.

Conflict rules for the system 100 may be managed via the campaign management servers 110 and distributed over the network 101 to the distribution servers 104. The campaign management servers 110 may also regularly update the conflict rules and transmit such updates to distribution servers via the network 101.

According to an embodiment of the invention, consistency of content assets stored in a cache 122 on a client device 102 may be managed as illustrated in FIG. 2B. The client device 102 and distribution server 104 may be configured, e.g., by suitable programming to implement cache consistency management before the client device 102 updates content assets stored in its cache 122. Specifically, the client device 102 may be programmed to implement a sequence of client-side operations 220 and the distribution server 104 may be programmed to implement a sequence of distribution-side operations 240. Specifically, after connecting to the distribution server 104 at 221, the client device 102 sends an update token 223 to the distribution server 104, as indicated at 222. The update token 223 has a value associated with it that indicates the most recent update that the client device 102 has implemented or attempted to implement. The distribution server 104 can then identify one or more content assets stored in the cache 122 using the update token value 223 and the update table 126, as indicated at 242. By way of example, if the client device 102 sends token 223 having a token value of two, the distribution server 104 may perform a lookup in the update table 126 to determine that the cache 122 might contain Asset D for content space Sp1 and Asset C for content space Sp2.

Subsequently, as indicated at 244, the distribution server 104 may determine whether a potential conflict exists between any of the assets that might be stored in the cache 122 and any assets in an update list determined from a token value for a current update and the update table 126. If it is determined that a conflict exists, at 246 the distribution server 104 may determine a resolution to the conflict that involves deleting one or more potentially conflicting assets from the cache 122. The distribution server 104 may then send an instruction 248 to the client device 102 to delete the one or more conflicting assets. The instruction 248 may include the current update token value and the client device 102 may reset its update token value to this updated value. In response to the instruction 248, the client device 102 may delete the potentially conflicting content assets from the cache 122, as indicated at 224. The client device 102 may notify the distribution server 104 that the deletion has been completed as indicated at 226. In response, the distribution server 104 may send an update signal 250 to the client device 102. The update signal 250 may be configured to configured to permit the client device 102 to proceed with an update of the content assets in the cache 122, e.g., along the lines described above with respect to FIG. 2B. If instead, it is determined that no potential conflict exists, the distribution server 104 may simply send the update signal 250 to the client device 102. The update signal 250 may optionally include the current update token value and the client device 102 may reset its update token value accordingly.

By way of example, suppose the current update token value for the distribution server 104 is token value 4. If the update table 126 is configured as in Table I, above, the distribution server 104 may determine that this update could place Asset E for content space Sp1 and Asset A for content space Sp2 in the cache 122. If the conflict rules 128 are configured, e.g., as in Table II, at 244 the distribution server 104 may determine from conflict rules 128 that Asset C and Asset E conflict and may a potential conflict may exist if Asset D is replaced with asset E but Asset C is not replaced with Asset A. The instruction 248 may therefore tell the client device 102 to delete Asset C from the cache 122.

The advantage of managing cache consistency in this manner may be seen by following an example of an update that follows cache consistency management. Again referring to FIG. 2B, the client device 102 may send the distribution server 104 a request for asset information as indicated at 228. The distribution server 104 may respond to the request with asset information, as indicated at 252. The asset information may identify update assets and a source of the update assets, e.g., as described above. By way of example, the distribution server may determine from the update table 126 and the current update token value of 4 that the client device 102 should obtain Asset E 253 from a content server 106 at address CDN. The distribution server 104 may relays this information to the client device 102 as indicated at 252. As indicated at 230, the client device 102 may then use this information to send a request 255 for Asset E 253 to the content server 106 at address CDN. In response, the content server 106 sends asset E 253 to the client device 102. The client device 102 may then replace Asset D with Asset E 253 in the cache 122, as shown at 258. Subsequently, the client device 102 may request asset information for content space Sp2 from the distribution server 104 as indicated at 232. In this example, the distribution server sends a response indicating that Asset A 257 may be obtained from the content server 106 at network address CDN. At 234, the client device sends a request 259 for Asset A 257. If the client device 102 never receives Asset D, e.g., due to a network outage, any potential for conflict between asset C and Asset E will have been avoided by the prior deletion of Asset C from the cache 122 at 224.

As discussed above, the client device 102 may be configured to replace content assets deleted from the cache 122 with benign assets from the mass storage 124. This ensures that client device 102 will have some content cached for display in content spaces in the event of a network outage. For example, after deleting Asset C at 224, the client device 102 may optionally copy benign Asset G from the mass storage device 124 to the cache 122 for content space Sp2. The client device 102 may then display content in content spaces Sp1 and Sp2 generated using Asset E and Asset G respectively as indicated at 236.

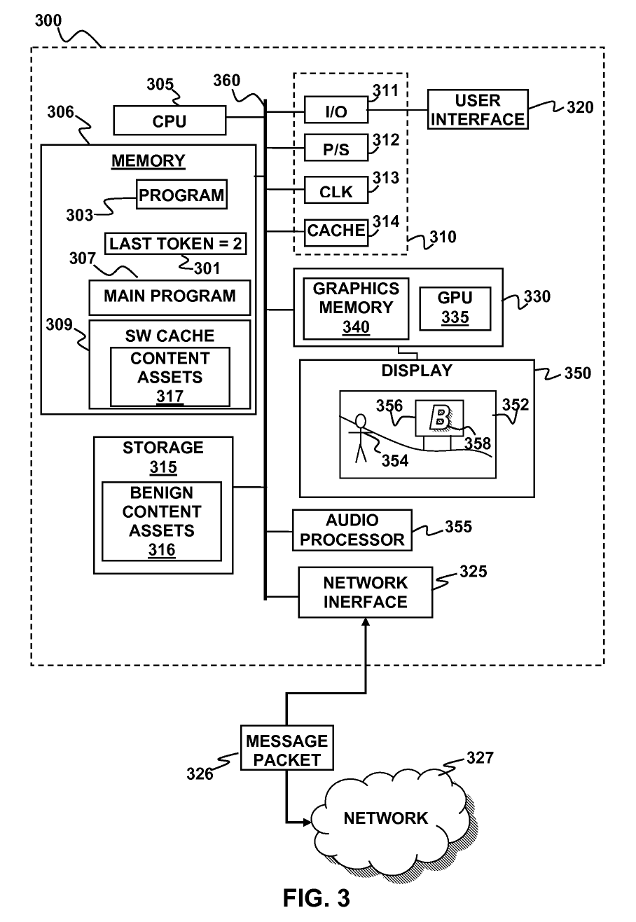

By way of example, the client devices 102 in the system 100 may be configured as shown in FIG. 3. FIG. 3 is a block diagram illustrating the components of a client device 300 according to an embodiment of the present invention. By way of example, and without loss of generality, the client device 300 may be implemented as a computer system, such as a personal computer, video game console, personal digital assistant, or other digital device, suitable for practicing an embodiment of the invention. The client device 300 may include a central processing unit (CPU) 305 configured to run software applications and optionally an operating system. The CPU 305 may include one or more processing cores. By way of example and without limitation, the CPU 305 may be a parallel processor module, such as a Cell Processor. An example of a Cell Processor architecture is described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.co.jp/, the entire contents of which are incorporated herein by reference.

A memory 306 is coupled to the CPU 305. The memory 306 may store applications and data for use by the CPU 305. The memory 306 may be in the form of an integrated circuit, e.g., RAM, DRAM, ROM, and the like). A computer program 303 may be stored in the memory 306 in the form of instructions that can be executed on the processor 305. The instructions of the program 303 may be configured to implement, amongst other things, certain steps of a method for managing consistency of cached content, e.g., as described above with respect to client-side operations 220 in FIG. 2B. By way of example, the program 303 may include instructions to send an update token value 301 to a distribution server. The token value 301 may be embedded in the memory 306 and may be updated by the program 303 when a new value is received from the distribution server. The program may also include instructions to delete one or more content assets from a cache in response to an instruction from the distribution server; and/or update the content assets stored in the cache following receipt of an update signal from the distribution server. The program 303 may operate in conjunction with one or more instructions configured to implement an interactive environment. By way of example, such instructions may be part of a main program 307, such as a video game program. The main program 307 may call the program 303, e.g., as a function or subroutine. Alternatively, the main program 307 may be a program for interfacing with a virtual world. Virtual worlds are described in commonly assigned U.S. patent application Ser. Nos. 11/682,281, 11/682,284, 11/682,287, 11/682,292, 11/682,298, and 11/682,299, the contents of all of which are incorporated herein by reference.

The client device 300 may also include well-known support functions 310, such as input/output (I/O) elements 311, power supplies (P/S) 312, a clock (CLK) 313 and cache 314. The client device 300 may further include a storage device 315 that provides non-volatile storage for applications and data. The storage device 315 may be used for temporary or long-term storage of auxiliary content assets 316 downloaded from a content server. By way of example, the storage device 315 may be a fixed disk drive, removable disk drive, flash memory device, tape drive, CD-ROM, DVD-ROM, Blu-ray, HD-DVD, UMD, or other optical storage devices.

The cache 314 may be a readily accessible memory hardware component that is separate and distinct from the main memory 306. In such a case, the cache 314 is sometimes referred to as a hardware cache. The memory 306 may also include a reserved and readily accessible region 309 sometimes referred to as a software cache. Content assets 317 may be stored in such a software cache. By way of example, the content assets 317 may be auxiliary content assets, such as advertising content assets. In some cases, e.g., wherein the storage device 315 is a disk drive or other storage device whose stored data may be overwritten, a software cache may be implemented using a specially, reserved region of the storage device 315. Although the content assets 317 are shown as being stored in a software cache 309 within the main memory, in embodiments of the invention the content assets 317 may alternatively be stored in the hardware cache 314 or within a software cache implemented using the storage device 315.

One or more user input devices 320 may be used to communicate user inputs from one or more users to the computer client device 300. By way of example, one or more of the user input devices 320 may be coupled to the client device 300 via the I/O elements 311. Examples of suitable input device 320 include keyboards, mice, joysticks, touch pads, touch screens, light pens, still or video cameras, and/or microphones. The client device 300 may include a network interface 325 to facilitate communication via an electronic communications network 327. The network interface 325 may be configured to implement wired or wireless communication over local area networks and wide area networks such as the Internet. The client device 300 may send and receive data and/or requests for files via one or more message packets 326 over the network 327.

The client device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 306. Pixel data may be provided to the graphics memory 340 directly from the CPU 305. Alternatively, the CPU 305 may provide the GPU 335 with data and/or instructions defining the desired output images, from which the GPU 335 may generate the pixel data of one or more output images. The GPU 335 may generate portions of the content of such output images using the content assets 317 stored in the software cache 309 or the hardware cache 314. The data and/or instructions defining the desired output images may be stored in memory 310 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The graphics subsystem 330 may periodically output pixel data for an image from the graphics memory 340 to be displayed on a display device 350. The display device 350 may be any device capable of displaying visual information in response to a signal from the client device 300, including CRT, LCD, plasma, and OLED displays. The computer client device 300 may provide the display device 350 with an analog or digital signal. By way of example, the display 350 may include a cathode ray tube (CRT) or flat panel screen that displays content, e.g., in the form of text, numerals, graphical symbols, images or video. Such content may include, e.g., one or more images representing a simulated environment 352 such as a video game or virtual world. In such an environment, a user may be represented by an avatar 354. Examples of avatars are described, e.g., in commonly assigned U.S. patent application Ser. Nos. 11/682,281, 11/682,284, 11/682,287, 11/682,292, 11/682,298, and 11/682,299, which have been incorporated herein by reference. The simulated environment may contain one or more auxiliary content spaces 356 in which auxiliary content 358 may be displayed. The auxiliary content may be generated using the cached assets 317.

In addition, the display 350 may include one or more audio speakers that produce audible or otherwise detectable sounds. To facilitate generation of such sounds, the client device 300 may further include an audio processor 355 adapted to generate analog or digital audio output from instructions and/or data provided by the CPU 305, memory 306, and/or storage 315.

The components of the client device 300, including the CPU 305, memory 306, support functions 310, data storage 315, user input devices 320, network interface 325, and audio processor 355 may be operably connected to each other via one or more data buses 360. These components may be implemented in hardware, software or firmware or some combination of two or more of these.

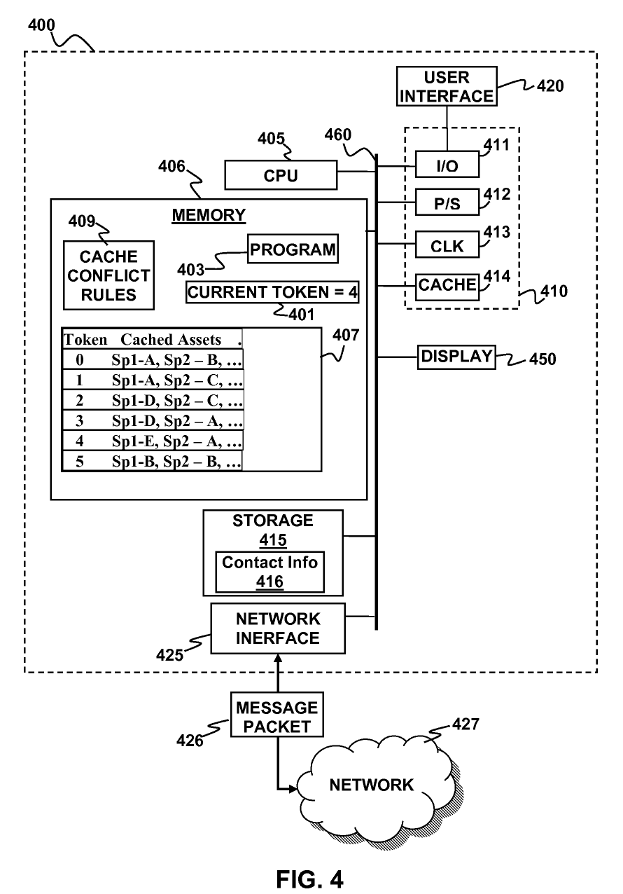

By way of example, and without loss of generality, the distribution servers 104 in the system 100 may be configured as shown in FIG. 4. According to an embodiment of the present invention, a distribution server 400 may be implemented as a computer system or other digital device. The distribution server 400 may include a central processing unit (CPU) 405 configured to run software applications and optionally an operating system. The CPU 405 may include one or more processing cores. By way of example and without limitation, the CPU 405 may be a parallel processor module, such as a Cell Processor.

A memory 406 is coupled to the CPU 405. The memory 406 may store applications and data for use by the CPU 405. The memory 406 may be in the form of an integrated circuit, e.g., RAM, DRAM, ROM, and the like). A computer program 403 may be stored in the memory 406 in the form of instructions that can be executed on the processor 405. A current update value 401 may be stored in the memory 406. In addition an update table 407 and cache conflict rules 409 may be embodied in the memory 406. By way of example, and without loss of generality, the conflict rules may be implemented as a lookup table, e.g., as described above with respect to Table II. The instructions of the program 403 may be configured to implement, amongst other things, certain steps of a method for cached content consistency management, e.g., as described above with respect to the distribution-side operations 240 in FIG. 2B. Specifically, the distribution server 400 may be configured, e.g., through appropriate programming of the program 403, to a) receive an update token value from a client device b) identify one or more content assets stored in a cache associated with the client device using the update token value and a current update token value 401; c) determine whether a potential conflict exists between any of the one or more assets stored in the cache and any of one or more assets in an update list determined from a current update token value and the update table; and; d) if it is determined at c) that a conflict exists, determine a resolution to the conflict that involves deleting one or more potentially conflicting assets from the client device's cache, and send an instruction to the client device to delete the one or more conflicting assets and/or e) notify the client device to proceed with an update of the content assets if it is determined at c) that no potential conflict exists. The potential for a conflict may be determined using the update table 407 and the conflict rules 409.

The distribution server 400 may also include well-known support functions 410, such as input/output (I/O) elements 411, power supplies (P/S) 412, a clock (CLK) 413 and cache 414. The mediation server 400 may further include a storage device 415 that provides non-volatile storage for applications and data. The storage device 415 may be used for temporary or long-term storage of contact information 416 such as distribution server addresses and cryptographic keys. By way of example, the storage device 415 may be a fixed disk drive, removable disk drive, flash memory device, tape drive, CD-ROM, DVD-ROM, Blu-ray, HD-DVD, UMD, or other optical storage devices.

One or more user input devices 420 may be used to communicate user inputs from one or more users to the mediation server 400. By way of example, one or more of the user input devices 420 may be coupled to the mediation server 400 via the I/O elements 411. Examples of suitable input device 420 include keyboards, mice, joysticks, touch pads, touch screens, light pens, still or video cameras, and/or microphones. The mediation server 400 may include a network interface 425 to facilitate communication via an electronic communications network 427. The network interface 425 may be configured to implement wired or wireless communication over local area networks and wide area networks such as the Internet. The mediation server 400 may send and receive data and/or requests for files via one or more message packets 426 over the network 427.

The components of the distribution server 400, including the CPU 405, memory 406, support functions 410, data storage 415, user input devices 420, and network interface 425, may be operably connected to each other via one or more data buses 460. These components may be implemented in hardware, software or firmware or some combination of two or more of these.

Embodiments of the present invention facilitate management of consistency of content assets cached on a client device without placing an undue burden for such management on the client device itself. By off-loading the responsibility for cache consistency management to a remote server, using token values to keep track of updates and performing cache consistency management prior to updates, embodiments of the present invention can avoid caching of potentially conflicting content assets.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. In a client device having a cache, a computer implemented cached content consistency management, comprising:
prior to updating one or more content assets stored in the cache
a) sending an update token value to a distribution server; and
b) deleting one or more content assets from the cache in response to an instruction from the distribution server; and/or
c) updating the content assets stored in the cache following receipt of an update signal from the distribution server.

2. The method of claim 1, further comprising receiving a new update token value from the distribution server and changing the update token value to the new update token value.

3. The method of claim 1 wherein b) further comprises: after deleting the one or more content assets from the cache, notifying the distribution server that the one or more content assets have been deleted.

4. The method of claim 1 wherein b) further comprises replacing the one or more contents with one or more corresponding replacement assets stored on storage device associated with the client device.

5. The method of claim 1, wherein c) comprises:
sending the distribution server an information request for an update to the content assets stored in the cache.

6. The method of claim 5, wherein c) further comprises receiving information identifying one or more updated content assets and information identifying one or more corresponding sources of the updated content assets in response to the information request.

7. The method of claim 6 wherein c) further comprises sending an asset request to the one or more sources, wherein the asset request includes the information identifying the one or more updated content assets.

8. The method of claim 7 wherein c) further comprises receiving the one or more updated content assets from the one or more sources in response to the asset request and replacing one or more content assets stored in the cache with the one or more updated content assets.

9. The method of claim 1 wherein the cached content assets include one or more auxiliary content assets.

10. The method of claim 9 wherein the auxiliary content assets include one or more advertising content assets.

11. The method of claim 1, further comprising displaying content with the client device using the content assets stored in the cache.

12. A client device, comprising:
a processor;
a memory coupled to the processor, the memory including a cache;
one or more instructions embodied in memory for execution by the processor, the instructions being configured to implement a method for cached content consistency management, the method comprising:
a) sending an update token value to a distribution server; and
b) deleting one or more content assets from the cache in response to an instruction from the distribution server; and/or
c) updating the content assets stored in the cache following receipt of an update signal from the distribution server.

13. The client device of claim 12, wherein the content assets stored in the cache include one or more auxiliary content assets.

14. The client device of claim 13, wherein the auxiliary content assets include one or more advertising content assets.

15. The client device of claim 12, further comprising a display configured to display content using the content assets stored in the cache.

16. In a distribution server, a computer implemented method for managing consistency of content assets stored in a cache on a client device, the method comprising:
a) receiving an update token value from a client device;
b) identifying one or more content assets stored in the cache using the update token value and an update table stored in a memory associated with the distribution server;
c) determining whether a potential conflict exists between any of the one or more assets stored in the cache and any of one or more assets in an update list determined from a current update token value and the update table; and
d) if it is determined at c) that a conflict exists, determining a resolution to the conflict that involves deleting one or more potentially conflicting assets from the cache, and sending an instruction to the client device to delete the one or more conflicting assets and/or
e) notifying the client device to proceed with an update of the content assets if it is determined at c) that no potential conflict exists.

17. The method of claim 16, wherein d) or e) further comprises sending the current update token value to the client device.

18. The method of claim 16, wherein d) further comprises notifying the client device to proceed with an update of the content assets after receiving confirmation from the client device that the potentially conflicting assets have been deleted from the cache.

19. The method of claim 16 wherein the content assets include one or more auxiliary content assets.

20. The method of claim 19 wherein the auxiliary content assets include one or more advertising content assets.

21. The method of claim 16, further comprising, after d) or e) sending content asset update information to the client device.

22. The method of claim 21 wherein the content asset update information includes information identifying one or more updated content assets and information identifying one or more corresponding sources of the updated content assets.

23. The method of claim 16, further comprising, after d) or e) sending content asset update information to the client device in response to an information request from the client device for an update to the content assets stored in the cache.

24. The method of claim 16 wherein c) includes comparing the content assets identified at b) against the assets in the update list using one or more conflict rules.

25. The method of claim 24 wherein the conflict rules are configured to prevent assets for two or more conflicting content items being stored in the cache at substantially the same time.

26. The method of claim 24 wherein the conflict rules are configured to prevent the client device from displaying two or more conflicting content items.

27. The method of claim 24 wherein the conflict rules are configured to prevent the client device from displaying two or more conflicting content items in violation of a contract.

28. A distribution server, comprising:
a processor;
a memory having embodied therein an update table; and
one or more instructions embodied in memory for execution by the processor, the instructions being configured to implement a method for managing consistency of content assets stored in a cache on a client device, the method comprising:
a) receiving an update token value from a client device;
b) identifying one or more content assets stored in the cache using the update token value and an update table stored in a memory associated with the distribution server;
c) determining whether a potential conflict exists between any of the one or more assets stored in the cache and any of one or more assets in an update list determined from a current update token value and the update table; and
d) if it is determined at c) that a conflict exists, determining a resolution to the conflict that involves deleting one or more potentially conflicting assets from the cache, and sending an instruction to the client device to delete the one or more conflicting assets and/or
e) notifying the client device to proceed with an update of the content assets if it is determined at c) that no potential conflict exists.

29. The distribution server of claim 25 wherein the content assets include one or more auxiliary content assets.

30. The distribution server of claim 26 wherein the auxiliary content assets include one or more advertising content assets.

31. The distribution server of claim 25 wherein the update table includes a plurality of asset listings, wherein each asset listing identifies one or more assets to be sent to the client device at a corresponding update token value.

32. The distribution server of claim 25, further comprising one or more conflict rules embodied in memory, wherein c) includes comparing the content assets identified at b) against the assets in the update list using the one or more conflict rules.

33. In a system having one or more client devices and a distribution server configured to communicate with the one or more client devices over a network, method for managing consistency of content assets stored in a cache on a client device, the method comprising:
a) sending an update token value for the client device to the distribution server;
b) identifying one or more content assets stored in the cache using the update token value and an update table stored in a memory associated with the distribution server;
c) determining with the distribution server whether a potential conflict exists between any of the one or more assets stored in the cache and any of one or more assets in an update list determined from a current update token value and the update table; and
d) if it is determined at c) that a conflict exists, determining a resolution to the conflict that involves deleting one or more potentially conflicting assets from the cache, sending an instruction from the distribution server to the client device to delete the one or more conflicting assets, and deleting one or more potentially conflicting content assets from the cache with the client device in response to the instruction from the distribution server; and/or
e) sending an update signal from the distribution server to the client device if it is determined at c) that no potential conflict exists, wherein the update signal is configured to permit the client device to proceed with an update of the content assets; and
f) updating the content assets stored in the cache.

34. The method of claim 33, wherein d) or e) further comprises sending the current update token value from the distribution server to the client device and changing the update token value to the current update token value.

35. The method of claim 33 wherein d) further comprises: after deleting the one or more content assets from the cache, sending a message from the client device to the distribution server, wherein the message indicates that the one or more content assets have been deleted.

36. The method of claim 33 wherein d) further comprises replacing the one or more contents with one or more corresponding replacement assets stored on storage device associated with the client device.

37. The method of claim 33, wherein f) comprises:
after d) or e) sending an information request for an update to the content assets stored in the cache from the client device to the distribution server.

38. The method of claim 37, wherein f) further comprises, sending content asset update information from the distribution server to the client device in response to the information request.

39. The method of claim 38 wherein f) further comprises sending an asset request to the one or more sources, wherein the asset request includes the content asset update information.

40. The method of claim 33, further comprising displaying content with the client device using the content assets stored in the cache.

41. The method of claim 33, wherein d) or e) further comprises sending the current update token value from the distribution server to the client device.

42. The method of claim 33, wherein d) further comprises sending the update signal from the distribution server to the client device after the distribution server receives confirmation from the client device that the potentially conflicting assets have been deleted from the cache, wherein the message is configured to instruct the client device to proceed with an update of the content assets.

43. The method of claim 33 wherein the content assets include one or more auxiliary content assets.

44. The method of claim 33 wherein the auxiliary content assets include one or more advertising content assets.

45. The method of claim 33 wherein c) includes comparing the content assets identified at b) against the assets in the update list using one or more conflict rules.

46. A cached content constancy management system, comprising:
a distribution server, having a memory with an update table embodied therein; and
a client device having a cache,
wherein the client device and distribution server are configured to communicate with each other over a network;
wherein the distribution server is configured to:
1) receive an update token value from the client device;
2) identify one or more content assets stored in the cache using the update token value and the update table;
3) determine whether a potential conflict exists between any of the one or more assets stored in the cache and any of one or more assets in an update list determined from a current update token value and the update table; and either
4) if it is determined at 3) that a conflict exists, determine a resolution to the conflict that involves deleting one or more potentially conflicting assets from the cache, and sending a delete instruction to the client device instructing the client device to delete the one or more conflicting assets.
5) send an update signal to the client device instructing the client device to proceed with an update of the content assets if it is determined at 3) that no potential conflict exists; or
wherein each client device is configured to,
a) send the update token value to a distribution server; and either
b) delete one or more content assets from the cache in response to the delete instruction from the distribution server; or
c) update the content assets stored in the cache upon receipt of the update signal from the distribution server.
